(19) United States
(12) Patent Application Publication
(10) Pub. No.: US 2007/0194481 A1
(43) Pub. Date: Aug. 23, 2007

(54) Hose production method

(75) Inventors: Shinji Iio, Komaki-shi (JP); Kazutaka Katayama, Kasugai-shi (JP); Hiroaki Ito, Kasugai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/635,614

(22) Filed: Dec. 8, 2006

(30) Foreign Application Priority Data
Feb. 23, 2006 (JP) 2006-047177

(51) Int. Cl. B29C 47/06

(52) U.S. Cl. 264/171.27

(57) ABSTRACT

A production method of a hose having a laminate structure consisting of three layers of an inner rubber layer, a resin layer, an outer rubber layer coaxially laminated in this order, wherein after the resin layer is extruded on an outer peripheral surface of the inner rubber layer, an outer peripheral surface of the resin layer is subjected to a direct type atmospheric pressure plasma treatment in advance of extrusion of the outer rubber layer.

### BACKGROUND OF THE INVENTION

1. Field of the Invention

The present invention relates to a production method of a hose having a resin layer formed inside a rubber layer.

2. Description of the Art

Conventionally, for improving low permeability of an automotive fuel hose, there has been proposed an intermediate layer formed of a resin such as a fluororesin or the like having low fuel permeability to be interposed between peripheral layers (rubber layers) of the fuel hose (see Japanese Unexamined Patent Publication No. 2004-150457). For a hose to be used in other purposes, there has been proposed a reinforcing resin layer as the intermediate layer to be interposed between the peripheral layers (rubber layers) of the hose.

The above hose has a laminate structure consisting of three layers, namely, inner rubber layer/resin layer/outer rubber layer, and is produced by laminating from the inner layer to the outer layer with an extruder.

Since the outer rubber layer is in a high temperature immediately after extrusion and is naturally cooled, the outer rubber layer tends to contract in the axial direction of the hose as the temperature is lowering after the extrusion. Further, adhesion between the outer rubber layer and the resin layer inside thereof is not strong. Accordingly, the outer rubber layer peels from the resin layer in an end portion of the hose, and is deformed to a flared shape having a diameter increasing toward the end of the hose. A hose having such a flared end portion will cause problems in the subsequent processes, namely, unadhesiveness of the end portion of the outer rubber layer to the resin layer, or deteriorated appearance of finished product. Although the peeling of the outermost rubber layer, i.e., increase of diameter, is restrained by tying up the end portion with a tape or a band, this process deteriorates manufacturing efficiency.

Further, the flared end portions of the hose should be cut off before being finished as a product, thereby resulting in a waste of costs for the materials of the cut off end portion.

In view of the foregoing, it is an object of the present invention to provide a production method of a hose having an improved adhesion between the outer rubber layer and the resin layer so as to restrict the peeling of the outer rubber layer from the resin layer at end portions of a hose.

### SUMMARY OF THE INVENTION

In order to achieve the above object, the present invention provides a production method of a hose having a laminate structure comprising three layers of an inner rubber layer, a resin layer, and an outer rubber layer coaxially laminated in this order, wherein after the resin layer is extruded on an outer peripheral surface of the inner rubber layer, an outer peripheral surface of the resin layer is subjected to a direct type atmospheric pressure plasma treatment in advance of extrusion of the outer rubber layer.

According to the method of the present invention, the outer peripheral surface of the resin layer to be disposed on the inner side of the outer rubber layer is subjected to a direct type atmospheric pressure plasma treatment before the outer rubber layer is extruded. This treatment allows the outer peripheral surface of the resin layer to be appropriately roughened and modified, that is, functional groups can be attached thereto. Therefore, the outer rubber layer extruded on the outer peripheral surface of the resin layer thus treated with a direct type atmospheric pressure plasma treatment is solidly adhered on the outer peripheral surface of the resin layer. As a result, despite the tendency of contraction in the axial direction during cooling, the outer rubber layer is prevented from peeling from the resin layer and from being deformed to a flared shape at the end portion of the hose.

As the plasma treatment other than the direct type atmospheric pressure plasma treatment, remote type atmospheric pressure plasma treatment and vacuum plasma treatment are known. However, the remote type atmospheric pressure plasma treatment is not capable of appropriately treating the outer peripheral surface of the resin layer, resulting in the peeling of the outer rubber layer from the resin layer. In the vacuum plasma treatment, a base body of the hose consisting of the inner rubber layer and the resin layer is caused to expand under the vacuum environment, resulting in an unstable configuration of the hose or a burst of the hose, in some cases.

According to the hose production method of the present invention, since the outer peripheral surface of the resin layer is subjected to a direct type atmospheric pressure plasma treatment in advance of extrusion of the outer rubber layer, the outer rubber layer can be solidly adhered on thus treated outer peripheral surface of the resin layer, and peeling of the outer rubber layer from the resin layer, namely, deformation of the end portion of the hose to a flared shape can be prevented. This results in an improvement in production efficiency of hoses as well as elimination of the problems such as the cutting-off of deformed end portions of produced hoses.

Specifically, according to the hose production method of the present invention, a resin layer formed of a fluororesin such as a tetrafluoroethylene-hexafluoropropylene-vinylidene fluoride copolymer (THV) and an outer rubber layer disposed on the outer periphery of the resin layer can be solidly adhered, despite poor adhesiveness between these layers.

### BRIEF DESCRIPTION OF THE DRAWINGS

FIG. 1 is a diagram schematically showing an embodiment of a hose production method according to the present invention;

FIG. 2 is a sectional view taken at X-X line in FIG. 1 showing a base body of the hose comprising an inner rubber layer and a resin layer;

FIG. 3 is a sectional view taken at Y-Y line in FIG. 1 showing the hose comprising the inner rubber layer, the resin layer and an outer rubber layer; and

FIG. 4 is a diagram schematically showing an atmospheric pressure plasma treatment apparatus.

### DESCRIPTION OF THE PREFERRED EMBODIMENTS

Embodiments of the present invention will hereinafter be described in detail with reference to the attached drawings. It should be noted that the present invention is not limited to the embodiments.

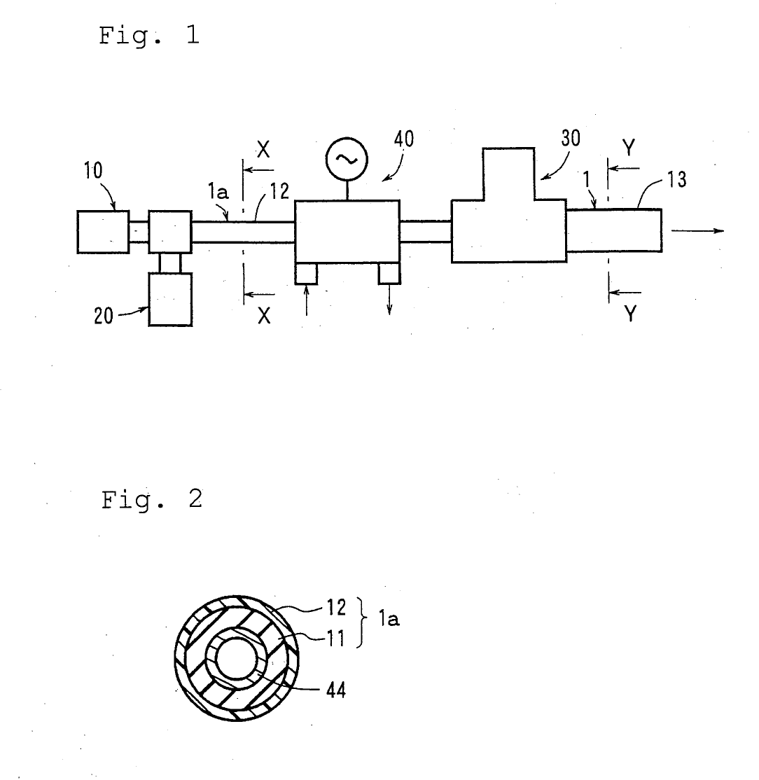

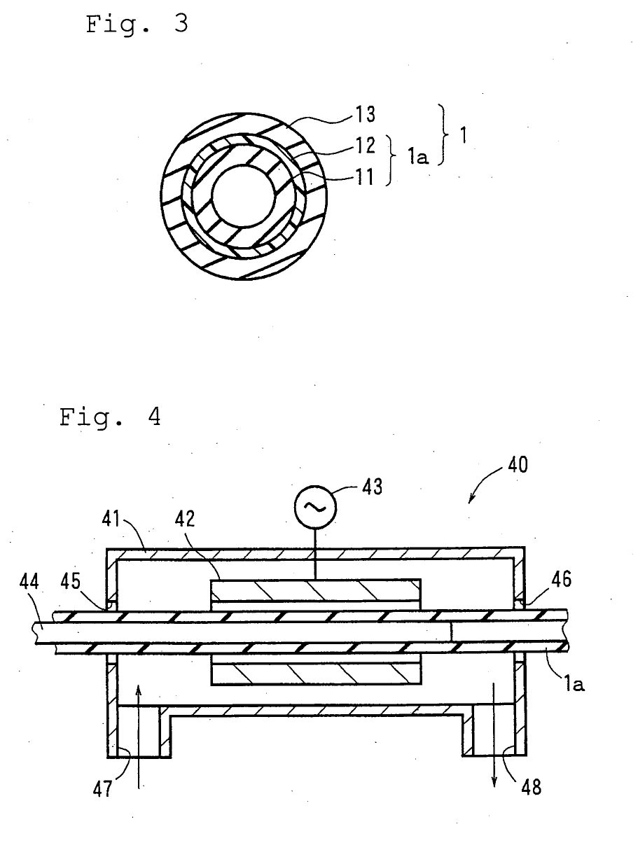

FIG. 1 shows an embodiment of the hose production method of the present invention. According to this embodiment, a first extruder 10 and a second extruder 20 sequentially extrude an inner rubber layer 11 and a resin layer 12 in tubular shapes, respectively, to form a tubular hose base body 1a consisting of 2 layers of the inner rubber layer 11 disposed on inner side and the resin layer 12 disposed on outer side as shown in FIG. 2. The hose base body 1a is formed coaxially with an outer peripheral surface of a pipe 44 (see FIG. 4) extending from the first extruder 10 into a direct type atmospheric pressure plasma treatment apparatus (hereinafter, referred to as “atmospheric pressure plasma treatment apparatus”) which will be explained below. Then, the hose base body 1a is continuously introduced into the atmospheric pressure plasma treatment apparatus 40, so that an outer peripheral surface of the resin layer 12 is subjected to a direct type atmospheric pressure plasma treatment (hereinafter, referred to as “atmospheric pressure plasma treatment”) while the hose base body 1a is moving. After passing through the atmospheric pressure plasma treatment apparatus 40, the hose base body 1a is introduced into a third extruder 30 for extruding an outer rubber layer 13 on the outer peripheral surface of the resin layer 12 (see FIG. 3). The hose 1 is thus obtained.

With the above method, the outer peripheral surface of the resin layer 12 is roughened and modified by means of the atmospheric pressure plasma treatment, that is, functional groups can be attached to the surface, thereby enhancing the strength of adhesion between thus plasma treated resin layer 12 and the outer rubber layer 13. As a result, the outer rubber layer 13 is prevented from peeling from the resin layer 12, namely, from being deformed to a flared shape, at end portions of the hose 1.

An inventive feature of the method of the present invention is the atmospheric pressure plasma treatment applied on the resin layer 12. The extrusion processes by the first to third extruders 10, 20, 30 before and after the plasma treatment are carried out by a conventionally known method.

Specifically, the atmospheric pressure plasma treatment apparatus 40 used in the hose production method of the present invention is an apparatus for carrying out a treatment by a direct type atmospheric pressure plasma. As shown in FIG. 4, the apparatus has a treatment chamber 41 of a box shape, and a cylindrical electrode 42 disposed in the chamber and connected to an AC source 43. The cylindrical electrode 42 has a centrum through which the pipe 44 extending from the first extruder 10 (see FIG. 1) is coaxially inserted with a clearance from the electrode 42 so as to function as a ground. The hose base body 1a coaxially passes through the clearance between the cylindrical electrode 42 and the pipe 44. The treatment chamber 41 is formed with an entrance opening 45 for allowing the hose base body 1a to enter thereinto on one end thereof (left end in FIG. 4), and an exit opening 46 for allowing the hose base body 1a to exit therefrom on the other end (right end in FIG. 4). Further, the treatment chamber 41 is formed with an inlet port 47 for supplying a gas into the chamber 41, and outlet port 48 for discharging the gas from the chamber 41.

A gas to be used in the atmospheric pressure plasma treatment is not particularly limited as long as an atmospheric pressure plasma is generated, but examples thereof include nitrogen, argon, oxygen, air, steam, and the like, which are used solely or in combination of more than one. Among these, nitrogen is preferably used in view of enhancement of adhesion between the resin layer 12 and the outer rubber layer 13. The gas for generating the atmospheric pressure plasma is supplied into the treatment chamber 41 through the inlet port 47.

The atmospheric pressure plasma treatment is carried out by coaxially introducing the hose base body 1a into the clearance between the cylindrical electrode 42 and the pipe 44, filling the treatment chamber 41 with a gas for preparing an atmosphere for generating atmospheric pressure plasma in the chamber 41, and applying AC voltage to the cylindrical electrode 42 to generate atmospheric pressure plasma. Then, the gas in the treatment chamber 41 is discharged through the outlet port 48. In the present invention, the wording “normal pressure” of the “atmospheric pressure plasma” means that the pressure in the treatment chamber 41 is not reduced or increased by a pump or the like in order to generate plasma, and the pressure in the treatment chamber 41 is not necessarily equivalent to the atmospheric pressure outside of the chamber 41.

Conditions for the atmospheric pressure plasma treatment are not particularly limited, but normally, a pulsing AC voltage is applied to the electrode 42 at a low voltage within a range of glow discharge that is not greater than a range of lightning discharge. The frequency of the AC source 43 is not particularly limited as long as the atmospheric pressure plasma is generated, but normally, the frequency is set within a range of 10 kHz to 200 kHz. Further, time for the atmospheric pressure plasma treatment is not particularly limited, but it is normally set within a range of 2 seconds to 2 minutes. Further, the amount of gas flow is set within a range of 1 liter/minute to 50 liters/minute.

Materials for the resin layer 12 to be subjected to the normal pressure treatment are not particularly limited, but examples thereof include: a fluororesin such as a tetrafluoroethylene-hexafluoropropylene-vinylidene fluoride copolymer (THV), a tetrafluoroethylene-hexafluoropropylene-vinylidene fluoride-perfluoroalkylvinyl ether copolymer, a polytetrafluoroethylene (PTFE), a polyvinylidene-fluoride (PVDF), a polychlorotrifluoroethylene (CTFE), an ethylene-chlorotrifluoroethylene copolymer (ECTFE), an ethylene-tetrafluoroethylene copolymer (ETFE), a hexafluoropropylene-tetrafluoroethylene copolymer (FEP), or a tetrafluoroethylene-perfluoroalkylvinyl ether copolymer (PFA); a polyamide resin such as an aromatic polyamide, a polyamide 11 (PA11), a polyamide 12 (PA12), or a polyamide 6 (PA6); and a thermoplastic resin such as an ethylene-vinyl alcohol copolymer, a polyester resin, or a polyarylene sulfide such as PPS. Where the hose 1 is produced as a fuel hose, the above listed fluororesins, which are excellent in low fuel permeability, are preferably used. The thickness of the resin layer 12 is determined depending on a use of the hose 1 and is not particularly limited, but where the hose 1 is produced as a fuel hose, for example, the thickness of the resin layer 12 is normally set within a range from 20 μm to 500 μm.

Materials for forming the outer rubber layer 13 which is disposed on the outer peripheral surface of the resin layer 12 are not particularly limited, but examples thereof include: an acrylonitrile-butadiene copolymer rubber (NBR), a NBR-PVC blend material of NBR and a polyvinyl chloride (PVC), a fluororubber (FKM), an acrylic rubber (ACM), a hydrin rubber, an epichlorohydrin rubber, an ethylene-propylene-dien terpolymer rubber (EPDM), a natural rubber (NR), a butadiene rubber (BR), a styrene-butadiene rubber (SBR), a butyl rubber (IIR), a halogenated IIR, a chloroprene rubber (CR), a chlorosulfonated polyethylene rubber (CSM), and a chlorinated polyethylene rubber (CPE). Where the hose 1 is produced as a fuel hose, NBR, NBR-PVC blend material, hydrin rubber, CSM, and CPE, which are excellent in resistance to abrasion, impact, and climate, are preferably used. The thickness of the outer rubber layer 13 is determined depending on a use of the hose 1 and is not particularly limited, but where the hose 1 is produced as a fuel hose, for example, the thickness of the outer rubber layer 13 is normally set within a range from 0.2 mm to 4 mm.

Materials for forming the inner rubber layer 11 which is disposed on the inner peripheral surface of the resin layer 12 are not particularly limited, but examples thereof include materials similar to the above listed materials for the outer rubber layer 13: an acrylonitrile-butadiene copolymer rubber (NBR), a NBR-PVC blend material of NBR and a polyvinyl chloride (PVC), a fluororubber (FKM), an acrylic rubber (ACM), a hydrin rubber, an epichlorohydrin rubber, an ethylene-propylene-dien terpolymer rubber (EPDM), a natural rubber (NR), a butadiene rubber (BR), a styrene-butadiene rubber (SBR), a butyl rubber (IIR), a halogenated IIR, a chloroprene rubber (CR). Where the hose 1 is produced as a fuel hose, NBR, NBR-PVC blend material, and FKM, which are excellent in resistance to fuel, are preferably used. The thickness of the inner rubber layer 11 is determined depending on a use of the hose 1 and is not particularly limited, but where the hose 1 is produced as a fuel hose, for example, the thickness of the inner rubber layer 11 is normally set within a range from 0.2 mm to 4 mm.

The three-layer structure of the hose 1 consisting of the inner rubber layer 11, the resin layer 12, and the outer rubber layer 13 according to the above embodiment may be provided with further layers on the outer periphery of the outer rubber layer 13, that is, a reinforcing layer having a polyester reinforcing fiber or a carbon fiber twisted therearound, a layer of other rubbers, a layer of other resins, or the like may be formed on the outside of the outer rubber layer 13. Alternatively, the resin layer 12 may include a plurality of resin layers formed of different types of resins from each other. Further, any other layers may be formed inside of the inner rubber layer 11.

The hose 1 is applicable to a hose for transporting fuels such as gasoline, alcohol-containing gasoline (gasohol), alcohol, hydrogen, light oil, dimethyl ether, diesel fuel, compressed natural gas (CNG) or liquefied petroleum gas (LPG); evaporations; or refrigerants such as fluorocarbon, hydrochlorofluorocarbon, water, or carbon dioxide to be used in air conditioners or radiators for automotive vehicles and other transport machines including aircraft; vehicles for industrial use such as a forklift, a wheeled tractor shovel, and a crawler crane; and railroad vehicles. Further, the hose 1 is applicable to a hose for transporting fluids for various equipments and instruments.

Next, an example of the invention and a conventional example are described.

### EXAMPLE OF THE INVENTION

A fuel hose consisting of three layers was produced in the manner as described in the forgoing paragraphs, using the following materials for forming each of an inner rubber layer, a resin layer, and an outer rubber layer.

### Preparation of Material for Inner Rubber Layer

A material for an inner rubber layer was prepared by blending 100 parts by weight of NBR (Nipol DN101, available from Zeon Corporation), 50 parts by weight of SRF (Semi Reinforcing Furnace) carbon black (SEAST S, available from Tokai Carbon, Co., Ltd.), 20 parts by weight of a plasticizer (RS-107, available from Asahi Denka Co., Ltd.), 5 parts by weight of a zinc oxide, 0.5 parts by weight of a sulfur, 2.1 parts by weight of TET, and 1.5 parts by weight of CZ, and then kneading the resulting mixture by means of a Banbury mixer and a mixing roll.

### Preparation of Material for Resin Layer

A fluororesin (THV-815G, available from Dyneon LLC) was prepared.

### Preparation of Material for Outer Rubber Layer

A material for an outer rubber layer was prepared by blending 100 parts by weight of NBR+PVC (Nipol DN508SCR, available from Zeon Corporation), 50 parts by weight of SRF (SEAST S, available from Tokai Carbon, Co., Ltd.), 30 parts by weight of a plasticizer (RS-107, available from Asahi Denka Co., Ltd.), 5 parts by weight of a zinc oxide, 0.5 parts by weight of a sulfur, 2.1 parts by weight of TET, and 1.5 parts by weight of CZ, and then kneading the resulting mixture by means of a Banbury mixer and a mixing roll.

### Production of Fuel Hose

As described in the forgoing paragraphs, an inner rubber layer having an inner diameter of 23 mm and a thickness of 2 mm, and a resin layer having a thickness of 150 μm were sequentially extruded into tubular shapes to form a tubular hose base body by means of a first extruder and a second extruder. The resulting hose base body was introduced into an atmospheric pressure plasma treatment apparatus for treating the outer peripheral surface of the resin layer. The atmospheric pressure plasma treatment was carried out by applying AC voltage of 145 W for 10 seconds at a frequency of 30 kHz in a nitrogen gas atmosphere. After the whole length of the base body was plasma treated, an outer rubber layer was extruded into a tubular shape having a thickness of 2 mm on the outer peripheral surface of the resin layer by means of a third extruder. Thus, a fuel hose of three layers having an inner diameter of 23 mm and an outer diameter of 31 mm was produced.

### CONVENTIONAL EXAMPLE

A fuel hose was produced in the same way as the above EXAMPLE OF THE INVENTION except that the atmospheric pressure plasma treatment was not carried out.

### Observation of End Portions of Hose

An end portion of each of thus obtained fuel hoses of the Examples was visually observed after one day had passed from the extrusion of the outer rubber layer. On the end portion of the fuel hose of Example of the Invention, peeling of the outer rubber layer was not observed. On the end portion of the fuel hose of the Conventional Example, peeling of the outer rubber layer was observed.

The above result shows that the production method of the present invention provides enhanced adhesion of the outer rubber layer to the resin layer as compared with the conventional production method.

What is claimed is:

1. A production method of a hose having a laminate structure comprising three layers of an inner rubber layer, a resin layer, and an outer rubber layer coaxially laminated in this order, wherein after the resin layer is extruded on an outer peripheral surface of the inner rubber layer, an outer peripheral surface of the resin layer is subjected to a direct type atmospheric pressure plasma treatment in advance of extrusion of the outer rubber layer.

2. A hose production method as set forth in claim 1, wherein the inner rubber layer comprises an acrylonitrile-butadiene copolymer rubber, or a blend of the acrylonitrile-butadiene copolymer rubber and a polyvinyl chloride; the resin layer comprises a fluororesin; and the outer rubber layer comprises a blend of the acrylonitrile-butadiene copolymer rubber and the polyvinyl chloride, or a hydrin rubber.

3. A hose production method as set forth in claim 2, wherein the fluororesin is a tetrafluoroethylene-hexafluoropropylene-vinylidene fluoride copolymer, or a tetrafluoroethylene-hexafluoropropylene-vinylidene fluoride-perfluoroalkylvinyl ether copolymer.
